(19) United States
(12) Patent Application Publication
(10) Pub. No.: US 2010/0085173 A1
(43) Pub. Date: Apr. 8, 2010

(54) METHOD FOR DETECTING VEHICLE-TO-VEHICLE DISTANCE AND SYSTEM THEREOF

(75) Inventors: Chih-Kun YANG, Hsinchu County (TW); Tzu-Chih LIN, Hsinchu County (TW)

Correspondence Address: RABIN & Berdo, PC, 1101 14TH STREET, NW, SUITE 500, WASHINGTON, DC, 20005, US

(73) Assignee: Altek Corporation, Hsinchu (TW)

(21) Appl. No.: 12/407,891

(22) Filed: Mar. 20, 2009

(30) Foreign Application Priority Data
Oct. 8, 2008 (TW) 097138791

(51) Int. Cl. B60Q 1/00; G06K 9/00

(52) U.S. Cl. 340/435; 382/106

(57) ABSTRACT

A method for detecting a vehicle-to-vehicle distance and a system thereof are applied in a first vehicle for detecting a distance between the first vehicle and a second vehicle. The method includes focusing on the second vehicle; capturing an image of the second vehicle after the focusing; analyzing the captured image to obtain at least one main feature in the image; determining whether the image is a vehicle license plate according to the main feature; calculating a focusing distance to the second vehicle after the focusing when the image is the vehicle license plate; outputting the calculated focusing distance as the vehicle-to-vehicle distance. A low-cost and reliable dynamic vehicle alarm and protection system can be realized based on the method for detecting a vehicle-to-vehicle distance.

### CROSS-REFERENCE TO RELATED APPLICATIONS

This non-provisional application claims priority under 35 U.S.C. § 119(a) on Patent Application No(s). 097138791 filed in Taiwan, R.O.C. on Oct. 8, 2008 the entire contents of which are hereby incorporated by reference.

### BACKGROUND OF THE INVENTION

1. Field of Invention

The present invention relates to a method for detecting a vehicle-to-vehicle distance and a system thereof, and more particularly to a method for detecting a vehicle-to-vehicle distance that may be realized by using an image pickup device and a system thereof.

2. Related Art

To save time in the busy life, in addition to the mass rapid transit (MRT) system, most people choose to drive to move between two locations. Unlike the MRT system, a person who drives can directly move between two destinations, and does not need to transfer for many times. Therefore, driving is more convenient.

However, the density of vehicles is over high due to the limited land area and the rapidly increasing population. Therefore, a driver often cannot keep safe distances from other vehicles, which may lead to rear collision when the driver fails to brake in time.

Currently, to prevent such collision accidents, many vehicle manufacturers have developed various techniques to improve the safety degree in driving. Among them, laser detection and Doppler radar detection techniques are the most commonly used. These techniques are difficult to implement, and it is expensive to apply these anti-collision techniques on vehicles. To save money for buying vehicles, many users choose not to use these anti-collision techniques, which, however, will make the driving more dangerous.

### SUMMARY OF THE INVENTION

Accordingly, the present invention is directed to a method for detecting a vehicle-to-vehicle distance and a system thereof, which solve a problem that a user is not willing to use an anti-collision technique because the technique is too expensive, and make driving safer.

A method for detecting a vehicle-to-vehicle distance of the present invention is applied in a first vehicle for detecting a distance between the first vehicle and a second vehicle. The method includes: focusing on the second vehicle; capturing an image of the second vehicle after the focusing; analyzing the captured image to obtain at least one main feature in the image; determining whether the image is a vehicle license plate according to the main feature; calculating a focusing distance to the second vehicle after the focusing when the image is the vehicle license plate; outputting the calculated focusing distance as the vehicle-to-vehicle distance.

The method for detecting a vehicle-to-vehicle distance of the present invention further includes continually storing the image and the vehicle-to-vehicle distance at different time points.

The method for detecting a vehicle-to-vehicle distance of the present invention further includes lowering a driving speed of the first vehicle when the vehicle-to-vehicle distance is smaller than a set value.

A system for detecting a vehicle-to-vehicle distance is applied in a first vehicle for detecting a distance between the first vehicle and a second vehicle. The system includes an image pickup device and an image recognition device. The image pickup device is embedded on a surface of the first vehicle, and is used for capturing an image of the second vehicle after focusing, and transmitting the image and a focusing distance of the second vehicle after the focusing. The image recognition device is electrically connected to the image pickup device, and is used for analyzing at least one main feature in the captured image after receiving the image and the focusing distance, determining whether the image is a vehicle license plate according to the at least one main feature, and using the focusing distance as a vehicle-to-vehicle distance when the image is the vehicle license plate.

The system for detecting a vehicle-to-vehicle distance of the present invention further includes a storage unit and a power system. The storage unit is disposed in the first vehicle, for continually storing the image and the vehicle-to-vehicle distance at different time points. The power system is disposed in the first vehicle, and is connected to the image recognition device, for automatically lowering a driving speed when the image is the car license plate and the vehicle-to-vehicle distance is smaller than a set value.

The method and the system for detecting a vehicle-to-vehicle distance of the present invention are applied in a first vehicle for obtaining a distance between the first vehicle and a second vehicle. When it is desired to obtain the distance between the first vehicle and the second vehicle, an image pickup device focuses on the second vehicle, and captures an image of the second vehicle after the focusing. The image pickup device transmits the image of the second vehicle after the focusing and a focusing distance to the second vehicle after the focusing to an image recognition device. The image recognition device analyzes the obtained image, and obtains a main feature in the image. Then, the image recognition device determines whether the image is a vehicle license plate according to the main feature. When the image is the vehicle license plate, the focusing distance is the vehicle-to-vehicle distance.

The image pickup device locks and focuses on a vehicle license plate of a vehicle ahead. Meanwhile, the image pickup device and the image recognition device are used to ensure that a focal point is the vehicle license plate. Thus, the distance between the image pickup device and the vehicle license plate ahead is determined, so as to estimate the distance between the vehicle where the image pickup device is installed and the vehicle ahead. The image pickup device and image recognition device can replace the conventional expensive anti-collision techniques, lower the cost for buying vehicles for common users, and make driving safer.

As for features and examples of the present invention, a preferred embodiment will be illustrated in detail with reference to the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a flow chart of a method for detecting a vehicle-to-vehicle distance according to a first embodiment of the present invention;

FIG. 2 is a flow chart of a method for detecting a vehicle-to-vehicle distance according to a second embodiment of the present invention;

FIG. 3 is a flow chart of a method for detecting a vehicle-to-vehicle distance according to a third embodiment of the present invention; and

FIG. 4 is a schematic view of a system for detecting a vehicle-to-vehicle distance of the present invention.

### DETAILED DESCRIPTION OF THE INVENTION

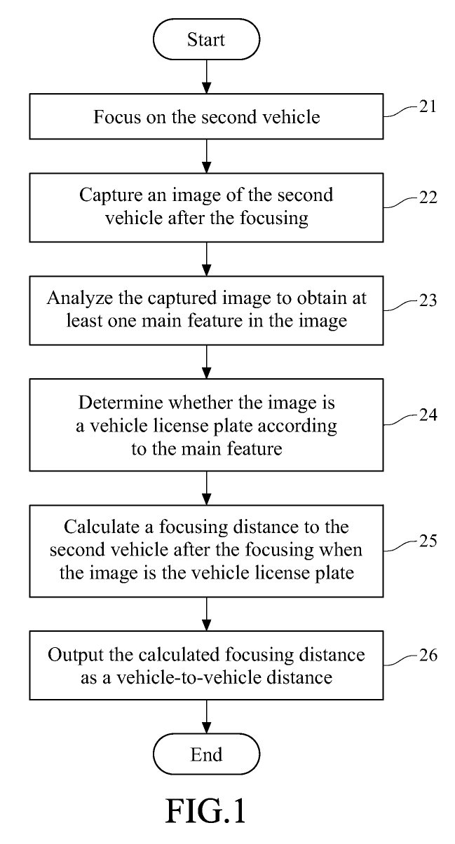

FIG. 1 is a flow chart of a method for detecting a vehicle-to-vehicle distance according to a first embodiment of the present invention. Referring to FIG. 1, the method for detecting a vehicle-to-vehicle distance according to this embodiment is applied in a first vehicle for obtaining a distance between the first vehicle and a second vehicle. The method for detecting a vehicle-to-vehicle distance according to this embodiment includes focusing on the second vehicle (Step 21); capturing an image of the second vehicle after the focusing (Step 22); analyzing the captured image to obtain at least one main feature in the image (Step 23); determining whether the image is a vehicle license plate according to the main feature (Step 24); calculating a focusing distance to the second vehicle after the focusing when the image is the vehicle license plate (Step 25); and outputting the calculated focusing distance as the vehicle-to-vehicle distance (Step 26).

In this embodiment, the at least one main feature includes at least one of a shape of the vehicle license plate, words and symbols on the vehicle license plate, numbers on the vehicle license plate, and a color of the vehicle license plate. The shape of the vehicle license plate may be a geometrical shape such as a rectangle, a triangle, or a circle. The words on the vehicle license plate may be words of different countries such as Chinese, English, and French, and the symbols on the vehicle license plate may be mathematical symbols or pattern symbols. The numbers on the vehicle license plate may be Arabic numerals from 0 to 9. The color of the vehicle license plate may be black characters on a white background or black words on a yellow background. In other words, manufacturers may prestore and preset the main feature (the shape of the vehicle license plate, the words and symbols on the vehicle license plate, and the numbers on the vehicle license plate) according to vehicle license plate styles of different countries. The captured image is analyzed to find the part consistent with the prestored and preset main feature, and determine whether the captured image is the vehicle license plate.

The step of focusing on the second vehicle and capturing the image of the focused second vehicle may be completed through an image pickup device (for example, a camera or a video camera). The step of analyzing the captured image to obtain the at least one main feature in the image and determining whether the image is the vehicle license plate according to the main feature may be completed through an image recognition device or image recognition software.

The method for detecting a vehicle-to-vehicle distance may be implemented by a microprocessor and a memory unit. The memory unit stores the image recognition software and steps and instructions of the method for detecting a vehicle-to-vehicle distance. After receiving the steps and instructions of the method for detecting a vehicle-to-vehicle distance, the microprocessor instructs the image pickup device to focus on the second vehicle and to capture the image of the second vehicle after the focusing in sequence. Then, the image recognition device or the image recognition software operating in the memory unit analyzes the main feature in the image, so as to determine whether the image is the vehicle license plate.

Here, the second vehicle is not limited to a vehicle right in front of the first vehicle, but also can be a vehicle beside the first vehicle or a vehicle right behind the first vehicle. The image pickup device is not limited to being installed on the front part of the first vehicle, but also can be installed on a side of the first vehicle or a rear part of the first vehicle. The second vehicle is not limited to a single vehicle right in front of the image pickup device, but also can be all vehicles within a shooting scope and focusing scope of the image pickup device. A multi-point focusing technique is used to focus on all vehicles in the focusing scope, and to capture the images of all vehicles after the focusing. By using the multi-point technique of the image pickup device and the image recognition device, the respective distances between the position of the first vehicle and all other vehicles in the shooting scope and focusing scope may be obtained.

The method for detecting a vehicle-to-vehicle distance according to this embodiment is applied in a first vehicle for obtaining a distance between the first vehicle and a second vehicle. When it is desired to obtain the distance between the first vehicle and the second vehicle, the second vehicle is focused, and an image of the second vehicle after the focusing is captured. Then, the captured image is analyzed to obtain the main feature in the image. The obtained main feature of the image is compared with the prestored and preset main feature, so as to determine whether the image is the vehicle license plate according to whether the main features are consistent. When the image is the vehicle license plate, the focusing distance for capturing the image after the focusing may be regarded as the distance between the first vehicle and the second vehicle, that is, a vehicle-to-vehicle distance. Thus, the distance between the first vehicle and the second vehicle ahead is estimated. This method may replace the conventional expensive anti-collision technique, which lowers the cost for buying vehicles for common users, and makes the driving safer.

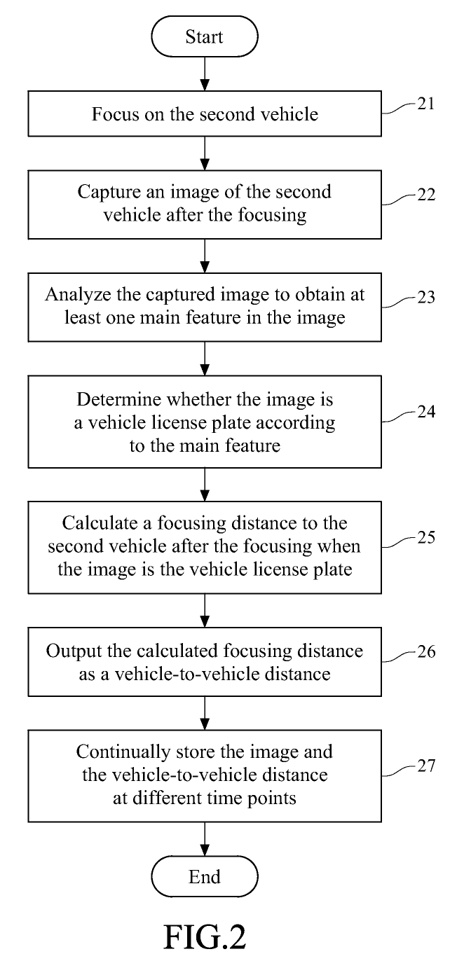

FIG. 2 is a flow chart of a method for detecting a vehicle-to-vehicle distance according to a second embodiment of the present invention. This embodiment is similar to the first embodiment. In this embodiment, after the calculated focusing distance is output as the vehicle-to-vehicle distance, the image and vehicle-to-vehicle distance at different time points may be stored continually (Step 27).

In other words, the image of the second vehicle after the focusing captured each time and the vehicle-to-vehicle distance may be stored and recorded continually, so as to provide a driving recorder. Thus, in case of an accident or emergent situation, accurate information about the accident situation and reason may be obtained from the driving recorder.

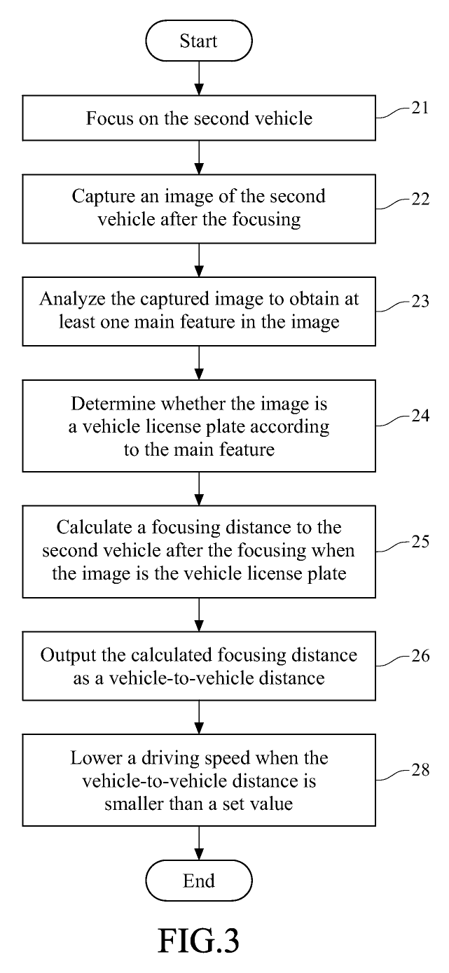

FIG. 3 is a flow chart of a method for detecting a vehicle-to-vehicle distance according to a third embodiment of the present invention. This embodiment is similar to the first embodiment. In this embodiment, after the calculated focusing distance is output as the vehicle-to-vehicle distance, if the vehicle-to-vehicle distance is smaller than a set value, a driving speed of the first vehicle is lowered (Step 28).

For example, the set value is between 1 m to 30 m, or between 5 m and 20 m. The set value may be preset by manufacturers. Certainly, a user may change the scope of the set value and the driving speed according to the driving speed or transportation conditions.

In other words, in addition to detecting the vehicle-to-vehicle distance, the method may be integrated with a power system in the vehicle to provide an active safety and protection function in driving. For example, a manufacturer sets during manufacturing that when the vehicle-to-vehicle distance is lower than a preset value, the power system automatically lowers the driving speed, so as to increase the distance to the vehicle ahead. Thus, the collision is prevented, and the active safety and protection function is realized.

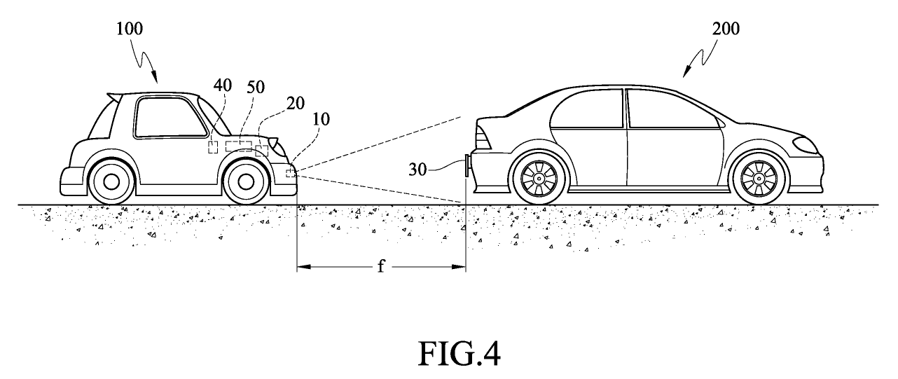

FIG. 4 is a flow chart of a system for detecting a vehicle-to-vehicle distance according to the present invention. The system for detecting a vehicle-to-vehicle distance according to this embodiment is applied in a first vehicle 100 for obtaining a distance between the first vehicle 100 and a second vehicle 200. The system for detecting a vehicle-to-vehicle distance according to this embodiment includes an image pickup device 10 and an image recognition device 20.

The image pickup device 10 is embedded on a surface of the first vehicle 100, and is used for capturing an image of the second vehicle 200 after focusing, and transmitting the image and a focusing distance f of the second vehicle 200 after the focusing.

The image recognition device 20 is electrically connected to the image pickup device 10, and is used for analyzing and capturing at least one main feature in the captured image after receiving the image and the focusing distance f, determining whether the image is a vehicle license plate 30 according to the at least one main feature, and using the focusing distance f as a vehicle-to-vehicle distance when the image is the vehicle license plate 30.

The image pickup device 10 may be a camera or a video camera.

The image recognition device 20 may be an electronic device operating image recognition software.

The system for detecting a vehicle-to-vehicle distance may include a microprocessor (not shown) and a memory unit (not shown). The memory unit stores the image recognition software and steps and instructions of the method for detecting a vehicle-to-vehicle distance. After receiving the steps and instructions of the method for detecting a vehicle-to-vehicle distance, the microprocessor (not shown) instructs the image pickup device 10 to focus on the second vehicle 200 and to capture the image of the second vehicle 200 after the focusing in sequence. Then, the image recognition device 20 or the image recognition software operating in the memory unit (not shown) analyzes the main feature in the image, so as to determine whether the image is the vehicle license plate 30.

In this embodiment, the at least one main feature includes at least one of a shape of the vehicle license plate 30, words and symbols on the vehicle license plate 30, numbers on the vehicle license plate 30. The shape of the vehicle license plate 30 may be a geometrical shape such as a rectangle, a triangle, or a circle. The words on the vehicle license plate 30 may be words of different countries such as Chinese, English, and French, and the symbols on the vehicle license plate 30 may be mathematical symbols or pattern symbols. The numbers on the vehicle license plate 30 may be Arabic numerals from 0 to 9. The color of the vehicle license plate 30 may be black characters on a white background or black words on a yellow background. In other words, manufacturers may prestore and preset the main feature (the shape of the vehicle license plate 30, the words and symbols on the vehicle license plate 30, and the numbers on the vehicle license plate 30) according to styles of the vehicle license plate 30 of different countries. The captured image is analyzed to find the part consistent with the prestored and preset main feature, and determine whether the captured image is the vehicle license plate 30.

Here, the second vehicle 200 is not limited to a vehicle right in front of the first vehicle 100, but also can be a vehicle beside the first vehicle 100 or a vehicle right behind the first vehicle 100. The image pickup device 10 is not limited to being installed on the front part of the first vehicle 100, but also can be installed on a side of the first vehicle 100 or a rear part of the first vehicle 100. The second vehicle 200 is not limited to a single vehicle right in front of the image pickup device 10, but also can be all vehicles within a shooting scope and focusing scope of the image pickup device 10. A multi-point focusing technique is used by the image pickup device 10 to focus on all vehicles in the focusing scope, and to capture the images of all vehicles after the focusing. By using the multi-point technique of the image pickup device 10 and the image recognition device 20, the respective distances between the position of the first vehicle 100 and all other vehicles in the shooting scope and focusing scope may be obtained.

The system for detecting a vehicle-to-vehicle distance according to this embodiment may further include a storage unit 40 and a power system 50. The storage unit 40 is disposed in the first vehicle 100, for continually storing the image and the vehicle-to-vehicle distance at different time points. The power system 50 is disposed in the first vehicle, and is connected to the image recognition device, for automatically lowering a driving speed when the image is the car license plate and the vehicle-to-vehicle distance is smaller than a set value.

The system for detecting a vehicle-to-vehicle distance according to the present invention is applied in a first vehicle 100 for obtaining a distance between the first vehicle 100 and a second vehicle 200. When it is desired to obtain the distance between the first vehicle 100 and the second vehicle 200, an image pickup device 10 focuses on the second vehicle 200, and captures an image of the second vehicle 200 after the focusing. The image pickup device 10 transmits the image of the second vehicle 200 after the focusing and a focusing distance f to the second vehicle 200 after the focusing to an image recognition device 20. The image recognition device 20 compares the obtained main feature of the image with the prestored and preset main feature, so as to determine whether the image is the vehicle license plate 30 according to whether the main features are consistent. When the image is the vehicle license plate 30, the focusing distance f for capturing the image after the focusing may be regarded as the distance between the first vehicle 100 and the second vehicle 200, that is, a vehicle-to-vehicle distance. Thus, the distance between the first vehicle 100 and the second vehicle 200 ahead is estimated. The image pickup device 10 and image recognition device 20 can replace the conventional expensive anti-collision techniques, lower the cost for buying vehicles for common users, and make driving safer.

The system for detecting a vehicle-to-vehicle distance of the present invention can integrate the storage unit 40 in the vehicle, and continually store and record the image of the second vehicle 200 after the focusing captured each time and the vehicle-to-vehicle distance (that is, the distance between the first vehicle and the second vehicle), so as to provide a driving recorder. Thus, in case of an accident or emergent situation, accurate information about the accident situation and reason may be obtained from the driving recorder.

In another aspect, the system for detecting a vehicle-to-vehicle distance of the present invention may integrate the power system 50 in the vehicle to provide an active safety and protection function in driving. For example, a manufacturer sets during manufacturing that when the vehicle-to-vehicle distance is lower than a preset value, the power system 50 automatically lowers the driving speed, so as to increase the distance to the vehicle ahead. Thus, the collision is prevented, and the active safety and protection function is realized.

What is claimed is:

1. A method for detecting a vehicle-to-vehicle distance, applied in a first vehicle, for obtaining a distance between the first vehicle and a second vehicle, the method comprising:
focusing on the second vehicle;
capturing an image of the second vehicle after the focusing;
analyzing the captured image to obtain at least one main feature in the image;
determining whether the image is a vehicle license plate according to the main feature;
calculating a focusing distance to the second vehicle after the focusing when the image is the vehicle license plate; and
outputting the calculated focusing distance as the vehicle-to-vehicle distance.

2. The method for detecting a vehicle-to-vehicle distance according to claim 1, further comprising:
continually storing the image and the vehicle-to-vehicle distance at different time points.

3. The method for detecting a vehicle-to-vehicle distance according to claim 1, wherein the at least one main feature comprises at least one of a shape of the vehicle license plate, words and symbols on the vehicle license plate, numbers on the vehicle license plate, and a color of the vehicle license plate.

4. The method for detecting a vehicle-to-vehicle distance according to claim 1, further comprising:
lowering a driving speed of the first vehicle when the vehicle-to-vehicle distance is smaller than a set value.

5. The method for detecting a vehicle-to-vehicle distance according to claim 4, wherein the set value is between 1 m and 30 m.

6. A system for detecting a vehicle-to-vehicle distance, applied in a first vehicle, for obtaining a distance between the first vehicle and a second vehicle, the system comprising:
an image pickup device, embedded on a surface of the first vehicle, for capturing an image of the second vehicle after focusing, and transmitting the image and a focusing distance of the second vehicle after the focusing; and
an image recognition device, electrically connected to the image pickup device, for analyzing at least one main feature in the captured image after receiving the image and the focusing distance, determining whether the image is a vehicle license plate according to the at least one main feature, and using the focusing distance as the vehicle-to-vehicle distance when the image is the vehicle license plate.

7. The system for detecting a vehicle-to-vehicle distance according to claim 6, wherein the at least one main feature comprises at least one of a shape of the vehicle license plate, words and symbols on the vehicle license plate, numbers on the vehicle license plate, and a color of the vehicle license plate.

8. The system for detecting a vehicle-to-vehicle distance according to claim 6, further comprising:
a storage unit, disposed in the first vehicle, for continually storing the image and the vehicle-to-vehicle distance at different time points.

9. The system for detecting a vehicle-to-vehicle distance according to claim 6, further comprising:
a power system, disposed in the first vehicle, and connected to the image recognition device, for automatically lowering a driving speed when the image is the car license plate and the vehicle-to-vehicle distance is smaller than a set value.

10. The system for detecting a vehicle-to-vehicle distance according to claim 9, wherein the set value is between 1 m and 30 m.
